(19) United States
(12) Patent Application Publication
(10) Pub. No.: US 2015/0310017 A1
(43) Pub. Date: Oct. 29, 2015

(54) Method, System and Program for Collaborative Innovation

(71) Applicant: Rajendra V. Deshpande, Camarillo, CA (US)

(72) Inventor: Rajendra V. Deshpande, Camarillo, CA (US)

(21) Appl. No.: 14/264,476

(22) Filed: Apr. 29, 2014

(51) Int. Cl. G06F 17/30

(52) U.S. Cl. CPC G06F 17/3053; G06Q 50/184

(57) ABSTRACT

A method, system and program comprise submitting an innovation summary to a server unit to be processed by an editorial review system. An acceptance of the innovation summary by the editorial review system posts the innovation summary. An innovation solicitation summary is submitted to the server unit to be processed by the editorial review system. An acceptance of the innovation solicitation summary by the editorial review system posts the innovation solicitation summary. Results of a search/match process of posted innovation summaries and posted innovation solicitation summaries are received. The search/match process at least utilizes a matching algorithm that uses defined innovation attributes, tags, text strings, and boost factors. A communication of an interest in a match in the received results is sent.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a database application. More particularly, the invention relates to internet based platform to accelerate collaborative innovation.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

With patent expirations and high research and development (R&D) costs, businesses typically are growingly seeking to share ideas, funds, and risk. While external innovation is becoming main stream, the conventional approaches to access it may be constrained by the infinite dispersion of innovation literature, limited outreach of entrepreneurs, and lack of mutual visibility among eligible business partners. For many years, some conventional approaches to partnering to develop new medical solutions may have originated from individual relationships, small group networks, business symposia, and other means of person-to-person interactions. These methods typically may depend more on interpersonal acquaintances and less on structured information exchanges, thereby they may suffer from the limitation of scalability. Typically beginning entrepreneurs and academic technology transfer offices may not have enough human resources or funds to surmount this limitation.

Venture capital and private equity investors usually may have relied on privileged interactions and information advantages with a few innovators, usually before the innovations are known widely to other potential (and at times more suitable) business partners. Young entrepreneurs and early stage companies typically may have to face this limitation of visibility. Declining budgets for innovation are typically a current reality for established businesses and young entrepreneurs alike. Venture capital funding in life sciences is known to have generally declined from $8.1 billion in 2007 to $5.4 billion in 2012. Conditions may create a circular dilemma in which innovation needs capital for de-risking, but the capital investors are seeking de-risked innovation.

At present, it is believed that the identification-evaluation-negotiation-syndication cascade for scientific and medical co-innovation opportunities yields a meager 1-3% partnering rate among innovation providers and seekers. A large portion of this inefficiency may stem from the dispersed innovation content that is neither easily accessible nor readily comprehensible. Keepers of this content may exclude many stakeholder participants within the innovation ecosystem, compromise providers' and seekers' visibility to each other's needs and offerings, and may not offer efficient means of mutual inquiry and follow-up.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that conventional information technology has provided the ability to collect, assemble, and disseminate vast amounts of information, covering wide and deep subject matter in scientific and medical disciplines. Some services provide massive databases of information pooled from publications, press releases, and business conventions. These intelligence services conventionally have primary/sole focus on pharmaceuticals in development, usually in established pipelines, but typically little-to-no coverage of medical devices, diagnostics, biomedical/manufacturing technologies, or research tools. Additionally, these services usually suffer from the following: (1) the data are collated by service companies' staff, not provided by the innovators themselves; they often may not present the current and accurate status of the innovation; (2) typically the information flow is unidirectional—from service providers to Innovation Seekers, usually with no participation from the Innovation Providers. These shortcomings may lead to a limitation of connectivity between Innovation Providers and Seekers.

A large portion of current typical inefficiencies may stem from limited outreach of young entrepreneurs, dispersed innovation content that is neither easily accessible nor readily comprehensible, closed information circles of venture capital investors, and narrow connectivity between academic technology transfer offices and industry licensing groups. The adverse impact of these typical inefficiencies in innovation opportunity identification may result in a small percentage of innovations turning into products, technologies that benefit patients, and the increasing cost of incrementally improved healthcare options.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary flow chart, in accordance with an embodiment of the present invention;

FIG. 2 illustrates an exemplary summary input form, in accordance with an embodiment of the present invention;

FIG. 3 illustrates exemplary Defined Innovation Attributes, in accordance with an embodiment of the present invention;

FIG. 4 illustrates an exemplary system, in accordance with an embodiment of the present invention; and

FIG. 5 illustrates a block diagram depicting a conventional client/server communication system.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and methods for providing an internet-based platform that collects, organizes, and matches innovations provided by innovation providers and sought by innovation seekers to enable fast and effective prospecting for co-innovation opportunities. Some embodiments of the present invention may provide web-based platforms for offering central, large repository of innovations in early research to late development stages searchable through various filters. Many embodiments may focus innovation content that transforms data and information into knowledge through Defined Innovation Attributes. In many embodiments a matching algorithm may use Defined Innovation Attributes, tags, text strings, and boost factors.

An embodiment of the present invention may offer an effective, post-search-find-pursue approach that may accelerate the development and commercialization of breakthrough medical products and technologies benefiting human health. An embodiment of the present invention may be a web-based platform for innovation providers and seekers to share a large number of innovations in health sciences. This may allow small and large innovators to present their novel creations to eligible business partners worldwide to strike partnerships for accelerated development and commercialization of their products and technologies. An embodiment of the present invention may allow established businesses to access and compare multiple innovations to pursue the best solutions for unmet human medical needs. In some embodiments an internet-based post-search-find-pursue system may be based on a matching algorithm that uses defined innovation attributes, tags, text strings, and boost factors. Boost factors may be used to refine the search/match algorithm to conduct high-fidelity identification of most-fitting data records. In a non-limiting example, matched entries of Innovation Providers and Seekers on Primary Offering and Stage of Development may be given a boost factor of 9. Matching Primary Application and Type of Business Sought may be given a boost factor of 3. Any matches in the rest of the textual entries may be given a boost factor of 1. The boost factors may be allocated according to the criticality of each of the Defined Innovation Attributes to innovation needs of Providers and Seekers. The greater the criticality of an input area the higher the boost factor. Many embodiments may include diverse participants such as, but not limited to, academic institutions (such as, but not limited to, universities, technology institutes, research hospitals), companies (such as, but not limited to, from newly-founded to established businesses), government/non-government organizations, private/public institutions, philanthropic foundations, and angel/venture capital investors.

An embodiment of the present invention may provide a central, dynamically updating database of emerging innovations in life sciences arranged under defined innovation attributes that organize, retrieve, and output content-rich innovation-synopses of optimal depth. An embodiment of the present invention may additionally provide supplemental documentation on each innovation to enable innovation seekers to compare multiple innovations against set criteria, and prioritize the most suitable innovation providers for potential partnering. An embodiment of the present invention may be a web-enabled platform that provides scalability, visibility, and connectivity to all innovation providers and seekers such as, but not limited to, from academia, industry, government organizations, private/public institutions, and capital investment firms, thereby accelerating co-innovation across an entire biomedical innovation landscape.

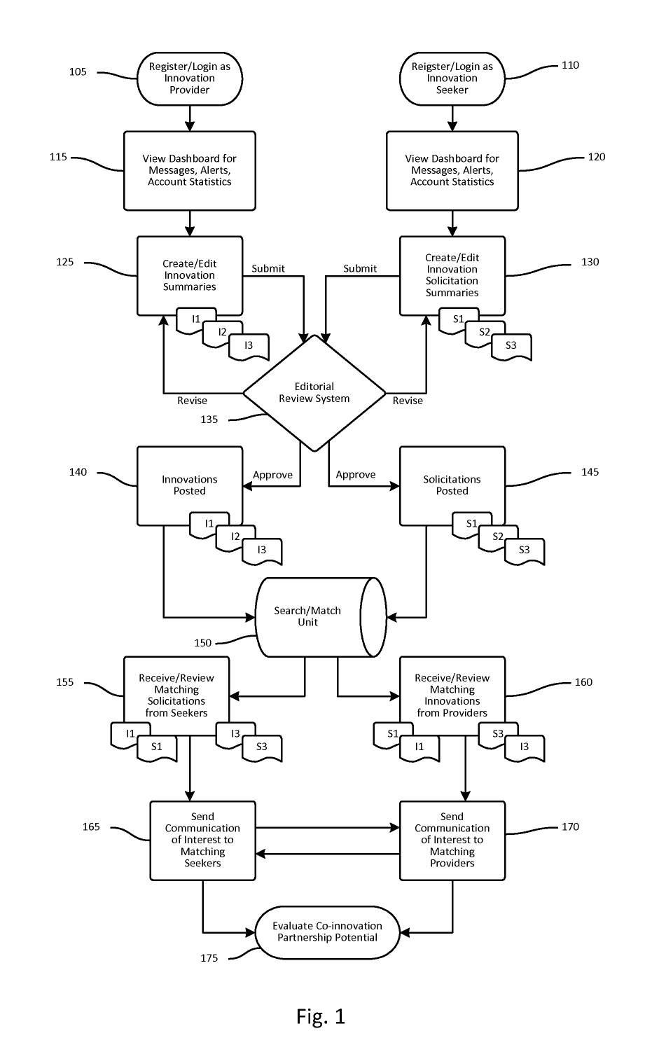

FIG. 1 illustrates an exemplary flow chart, in accordance with an embodiment of the present invention. In the present embodiment, an Innovation Provider may register and/or login at a step 105. An Innovation Seeker may register and/or login in a step 110. In a non-limiting example, the present invention may provide user registration and role-based security such as, but not limited to, specific fields of user profile, specific security rules for permissions to read/write data such as, but not limited to, to list, view, create, edit, delete, export, registration information, login/password setup/changes, etc. Once registered the Innovation Providers and Innovation Seekers may proceed to a Dashboard in a step 115 and a step 120 to view information including but not limited to, messages, alerts and account statistics, innovation news, crowdfunding updates, industry trends, success stories etc.

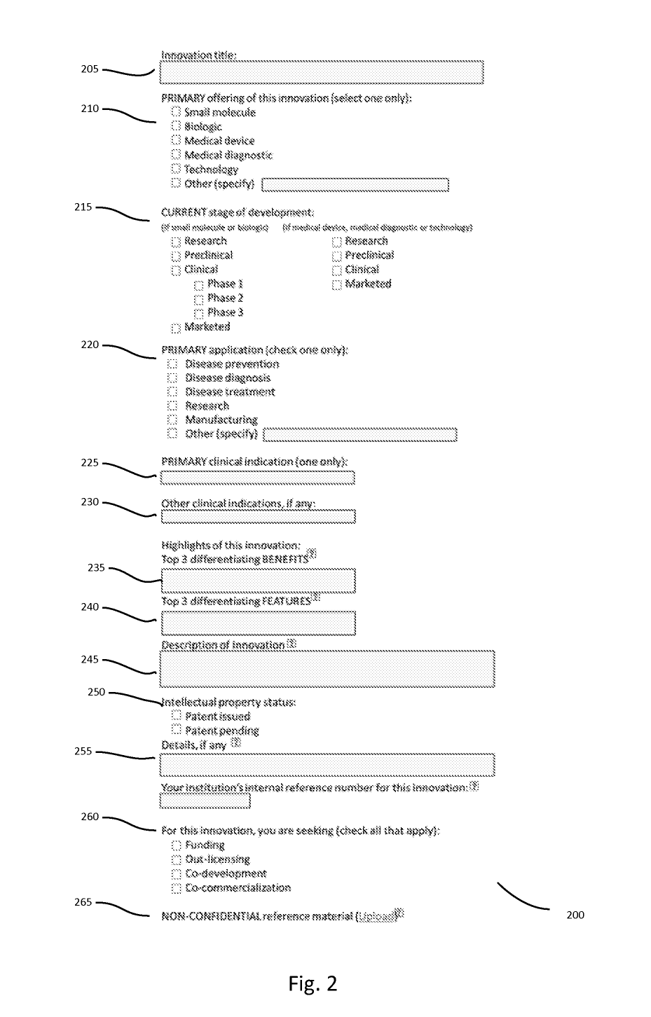

The Innovation Provider may be provided with an innovation summary input form in a step 125. An exemplary form is shown in FIG. 2. The Innovation Provider may then use this form to draft a submission for an innovation. The draft of the submission may be input to an editorial review system in a step 135. In the present embodiment, the editorial review system may include, without limitation, authorized users that have access to the administrative system to filter and sort submissions, view content, provide comments, update status, and notify submitters. In alternate embodiments, the Innovation Provider may be notified in the Dashboard. As a non-limiting example, medical writers may review the submissions for accuracy, brevity, and consistency. In alternate embodiments, the editorial review may comprise an automated system. In other alternate embodiments, the editorial review system may be omitted. If the editorial review system determines that revisions are required to the submissions, then the Innovation Provider is notified and the Innovation Provider may edit the submission in the step 125. If the submissions are accepted, then the submissions are posted in a step 140.

The Innovation Seeker may be provided with a solicitation summary input form in a step 130. The solicitation summary input form may be similar to the exemplary form shown in FIG. 2. The Innovation Seeker may then use this form to draft a submission for a solicitation. The draft of the submission may be input to an editorial review system in a step 135. In the present embodiment, the editorial review system may include, without limitation, authorized users that have access to the administrative system to filter and sort submissions, view content, provide comments, update submission/review status, and notify submitters. In alternate embodiments, the Innovation Seeker may be notified in the Dashboard. As a non-limiting example, medical writers may review the submissions for accuracy, brevity, and consistency. In alternate embodiments, the editorial review may comprise an automated system. In other alternate embodiments, the editorial review system may be omitted. If the editorial review system determines that revisions are required to the submissions, then the Innovation Seeker is notified and the Innovation Seeker may edit the submission in the step 130. If the submissions are accepted, then the submissions are posted in a step 145.

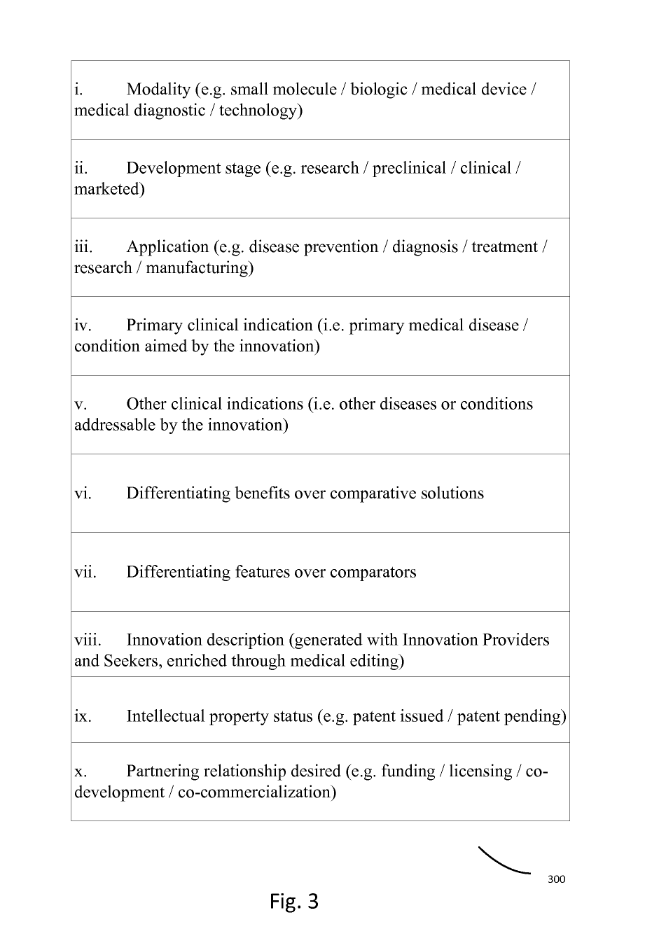

Posted submissions from step 140 and step 145 may be input to a search/match unit in a step 150. The search/match unit may provide methods and means for tuning search indexes and forming queries against that search index in order to provide relevant results. In many embodiments a matching algorithm may use Defined Innovation Attributes, tags, text strings, and boost factors. An example of Defined Innovation Attributes is shown in FIG. 3. A search/match algorithm may be architected to formulate solicitation requests as queries against an index of innovations where the results may be sent to the Innovation Seeker in a step 160. The search/match algorithm may be architected to formulate innovations as queries against an index of solicitations where the results may be sent to the Innovation Provider in a step 155. In some embodiments a workflow may be implemented for seekers to flag innovations of interest, move them through a selection process, and reference them to initiate communications with the providers in a step 170. In some embodiments a workflow may be implemented for providers to flag solicitations of interest, move them through a selection process, and reference them to initiate communications with the seekers in a step 165. In some alternate embodiments, Innovation Providers and Innovation Seekers may communicate via the Dashboard. In some alternate embodiments, Innovation Providers and Innovation Seekers may communicate directly using supplied contact information. In a step 175 Innovation Providers and Innovation Seekers may evaluate potential partnership agreements.

FIG. 2 illustrates an exemplary summary input form, in accordance with an embodiment of the present invention. Form 200 may be provided to the Innovation Providers in the step 125 for creating innovation summaries. Form 200, or a variation thereof, may also be provided to the Innovation Seeker in the step 130 for creating innovation solicitations. Input areas 205-260 provide means for the Innovation Providers to supply details of the innovation. Information from this form may be extracted for the Defined Innovation Attributes shown in FIG. 3. In the present embodiment, Innovation Providers may select 265 to upload additional materials to be part of the submission. As a non-limiting example, these materials may include, but not limited to, reference materials, published paper, etc. In the present embodiment, Innovation Seekers may select 265 to upload additional materials to be part of the submission. As a non-limiting example, these materials may include, but not limited to, brochures, funding information, etc. The present embodiment may be directed to the medical industry. Other alternate embodiments may encompass other businesses or industries.

The boost factors may be implemented in the matching/scoring algorithm to advance to the top of the search output those matched innovation summaries and solicitations that have the most critical input areas identically or closely matched. Thus, as a further non-limiting example, if an Innovation Seeker is seeking a co-development opportunity for a medical device in preclinical development to diagnose diabetes, an innovation summary describing a Medical Device (boost 9; input area 210) in Preclinical Development (boost 9; input area 215) for the purpose of Disease Diagnosis (boost 9; input area 220) of Diabetes (boost 1; input area 225) to be pursued for Co-development (boost 9; input area 260) may be placed higher in the search results than one describing a Medical Device (boost 9; input area 210) in Research (boost 0; input area 215) for Disease Prevention (boost 0; input area 220) of Diabetes (boost 1; input area 225) to be pursued for Out-licensing (boost 0; input area 260).

FIG. 3 illustrates exemplary Defined Innovation Attributes, in accordance with an embodiment of the present invention. In the present embodiment, at least ten defined attributes may be extracted from the submissions. These may be used by the search/match unit to match providers and seekers. Other alternate embodiments may use fewer or more attributes. The present embodiment may be directed to the medical industry. Other alternate embodiments may encompass other businesses or industries.

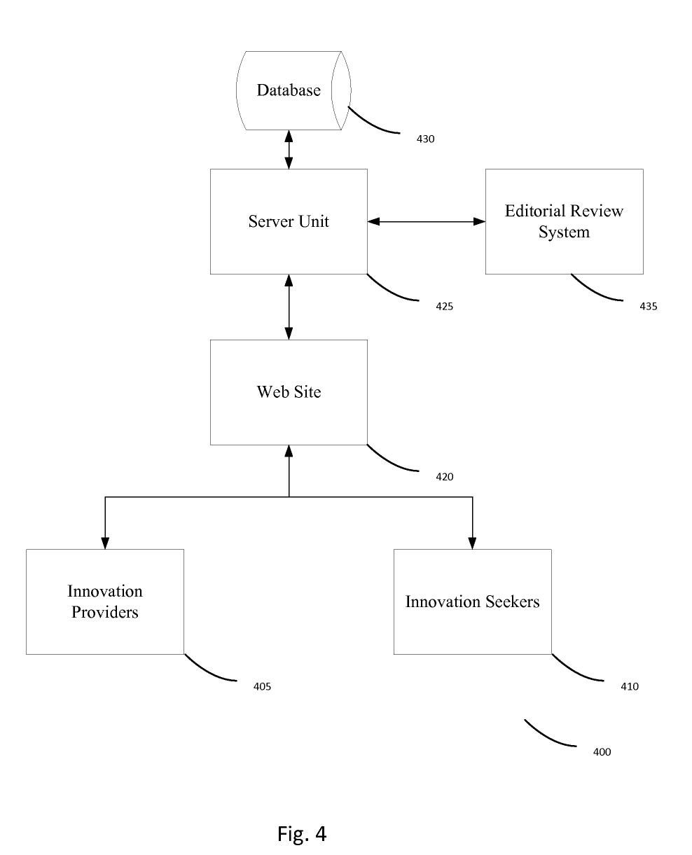

FIG. 4 illustrates an exemplary system, in accordance with an embodiment of the present invention. In the present embodiment, Innovation Providers 405 and Innovation Seekers communicate bi-directionally with server unit 425 through web site 420. Server unit 425 stores and retrieves submissions using database 430. Editorial review system accesses submissions for review via server unit 425.

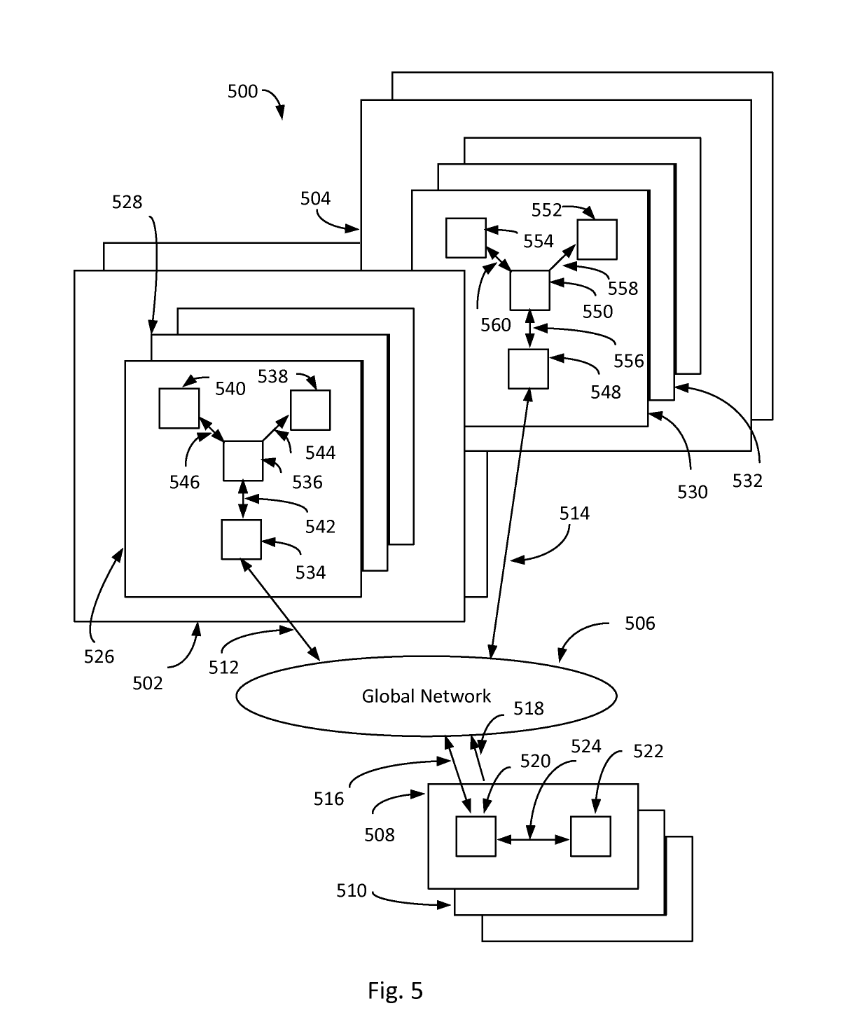

FIG. 5 illustrates a block diagram depicting a conventional client/server communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate with each other and with every other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 556 may communicate the return information to GUI 558 via communication channel 544. User may then view the return information on GUI 538.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: web site hosting and the editorial review system.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an internet based platform to accelerate collaborative innovation according to the present invention will be apparent to those skilled in the art. Various aspects of the invention have been described above by way of illustration, and the specific embodiments disclosed are not intended to limit the invention to the particular forms disclosed. Embodiments of the present invention may support innovation providers and seekers in any industry with a variation of the sample summary form. These industries may include, but not limited to, automobile, finance, entertainment, transportation, energy, agriculture, crowdsourcing etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
submitting an innovation summary to a server unit to be processed by an editorial review system, wherein an acceptance of the innovation summary by the editorial review system posts the innovation summary;
submitting an innovation solicitation summary to the server unit to be processed by the editorial review system, wherein an acceptance of the innovation solicitation summary by the editorial review system posts the innovation solicitation summary;
receiving results of a search/match process of posted innovation summaries and posted innovation solicitation summaries, wherein the search/match process at least utilizes a matching algorithm that uses defined innovation attributes, tags, text strings, and boost factors; and
sending a communication of an interest in a match in the received results.

2. The method as recited in claim 1, further comprising the steps of: receiving a notification of a needed revision in a submission; and submitting a revised submission for processing by the editorial review system.

3. The method as recited in claim 1, further comprising the step of receiving information from a dashboard unit, the information at least comprising messages, alerts and account statistics.

4. The method as recited in claim 1, further comprising the step of uploading additional materials to be part of a submission.

5. The method as recited in claim 1, in which the defined innovation attributes at least comprise parameters identified in posted innovation summaries and posted innovation solicitation summaries.

6. The method as recited in claim 1, in which the boost factors advance, to the top of the search/match process results, those matched innovation summaries and solicitations that have the most defined innovation attributes closely matched.

7. The method as recited in claim 1, in which the editorial review system at least comprises authorized users that have access to filter and sort submissions, view content, provide comments, update status, and notify submitters.

8. The method as recited in claim 1, in which at least said submitting, receiving and sending are communicated through a web site.

9. The method as recited in claim 1, in which the posted innovation summaries and posted innovation solicitation summaries comprise medical products and technologies.

10. A system comprising:
one or more client units being configured to be operable for at least submitting innovation summaries and for submitting an innovation solicitation summaries;
a web site being configured to be operable for communication with said one or more client units;
a server unit being configured to be operable for communication with said web site for receiving said innovation summaries and innovation solicitation summaries, said server unit being further operable for executing a search/match process of posted innovation summaries and posted innovation solicitation summaries, said search/match process at least utilizing a matching algorithm that uses defined innovation attributes, tags, text strings, and boost factors, said server unit being further operable for returning results of said search/match process and contact information to said one or more client units through said web site, said contact information enabling communication of an interest in a match in the returned results; and
an editorial review system in communication with said server unit, said editorial review system being configured to be operable for processing said innovation summaries and innovation solicitation summaries, wherein an acceptance of a summary posts said summary.

11. The system as recited in claim 10, in which: said posted innovation summaries and posted innovation solicitation summaries comprise medical products and technologies; said editorial review system at least comprises authorized users that have access to filter and sort submissions, view content, provide comments, update status, and notify submitters; said editorial review system is further operable for sending a notification of a needed revision in a submission; said one or more client units are further operable for uploading additional materials to be part of a submission and for receiving information from a dashboard unit, said information at least comprising messages, alerts and account statistics; said defined innovation attributes at least comprise parameters identified in posted innovation summaries and posted innovation solicitation summaries; said boost factors advance, to the top of the search/match process results, those matched innovation summaries and solicitations that have the most defined innovation attributes closely matched;

12. A non-transitory computer-readable storage medium with an executable program stored thereon, wherein the program instructs one or more processors to perform the following steps:
submitting an innovation summary to a server unit to be processed by an editorial review system, wherein an acceptance of the innovation summary by the editorial review system posts the innovation summary;
submitting an innovation solicitation summary to the server unit to be processed by the editorial review system, wherein an acceptance of the innovation solicitation summary by the editorial review system posts the innovation solicitation summary;
receiving results of a search/match process of posted innovation summaries and posted innovation solicitation summaries, wherein the search/match process at least utilizes a matching algorithm that uses defined innovation attributes, tags, text strings, and boost factors; and
sending a communication of an interest in a match in the received results.

13. The program instructing the processor as recited in claim 12, further comprising the steps of: receiving a notification of a needed revision in a submission; and submitting a revised submission for processing by the editorial review system.

14. The program instructing the processor as recited in claim 12, further comprising the step of receiving information from a dashboard unit, the information at least comprising messages, alerts and account statistics.

15. The program instructing the processor as recited in claim 12, further comprising the step of uploading additional materials to be part of a submission.

16. The program instructing the processor as recited in claim 12, in which the defined innovation attributes at least comprise parameters identified in posted innovation summaries and posted innovation solicitation summaries.

17. The program instructing the processor as recited in claim 12, in which the boost factors advance, to the top of the search/match process results, those matched innovation summaries and solicitations that have the most defined innovation attributes closely matched.

18. The program instructing the processor as recited in claim 12, in which the editorial review system at least comprises authorized users that have access to filter and sort submissions, view content, provide comments, update status, and notify submitters.

19. The program instructing the processor as recited in claim 12, in which at least said submitting, receiving and sending are communicated through a web site.

20. The program instructing the processor as recited in claim 12, in which the posted innovation summaries and posted innovation solicitation summaries comprise medical products and technologies.
